(19) United States
(12) Patent Application Publication
(10) Pub. No.: US 2010/0095326 A1
(43) Pub. Date: Apr. 15, 2010

(54) PROGRAM CONTENT TAGGING SYSTEM

(76) Inventor: Edward L. Robertson, III, Marina Del Rey, CA (US)

Correspondence Address: Cislo & Thomas LLP, 1333 2nd Street, Suite #500, Santa Monica, CA, 90401-4110, US

(21) Appl. No.: 12/580,228

(22) Filed: Oct. 15, 2009

Related U.S. Application Data
(60) Provisional application No. 61/196,112, filed on Oct. 15, 2008.
(60) Provisional application No. 61/185,538, filed on Jun. 9, 2009.

(51) Int. Cl. H04N 5/445

(52) U.S. Cl. 725/40

(57) ABSTRACT

A program content tagging system for facilitating the development of an interactive social network during the viewing of a program comprising a base station, a database, an output device, and an input device. The base station serves as the conduit for bidirectional communication between the user and the output device. The database stores a library of program content and/or other program content identification to provide a means for identifying the program content transmitted to the user. The output device allows the user to view any additional information synchronized with the program content. The input device allows the user to request or send information to the base station for processing. The user may activate a tag mark displayed on the output device to view additional information. With this information users, vendors, and visitors can engage in commerce through the use of advertisements and sales of goods and services.

### CROSS-REFERENCE TO RELATED APPLICATION

This patent application claims the benefit of U.S. Provisional Patent Application Ser. No. 61/196,112, entitled “Entertainment Content Tagging,” filed Oct. 15, 2008 and Provisional Patent Application Ser. No. 61/185,538, entitled “Entertainment Content Tagging”, filed Jun. 9, 2009, which applications are incorporated in their entirety here by this reference.

### BACKGROUND OF THE INVENTION

1. Technical Field

This invention relates to an interactive media.

2. Background Art

Although the computer is as much of a common household item as the television, the interactive capabilities of the computer have yet to be integrated into a television. Watching television, whether it is a program broadcasted through the air waves, satellite, cable, or even DVD, is still a passive activity of unidirectional information flow. Often times viewers of a program would like to have background information regarding the program, the actors, or the products shown in the program without interrupting the flow of the program or without having to leave the television to go to a computer to access the Internet to seek the additional information. Even with the flood of infomercials, the viewer must still pick up a telephone or access a computer to make a purchase.

Some programs are displayed with “pop up” screens to give additional information about a particular scene, actor, or product. Others allow users to text information using a cellphone. Still others embed extra data into the feeds. But again, this is unidirectional information since the viewer did not request such information. Furthermore, embedding extra data into the transmission feeds requires the tedious process of editing the original work.

Thus, there is a need for a system that allows for real-time interaction between a viewer and a social network of people and entities associated with the program, to make viewing pleasure a more comprehensive, interactive, and robust experience to help improve the social networking opportunities of the viewers without significantly altering the existing content.

### BRIEF SUMMARY OF INVENTION

The present invention is directed to a program content tagging system that makes program viewing an interactive and comprehensive process where users can request, send, and view additional information associated with the program that normally would not be provided with the program. Such a program content tagging system comprises a base station, a database, an output device, and an input device. The base station serves as the conduit for bidirectional communication between the user and the output device. The database stores a library of program content and/or other program content identification to provide a means for identifying the program content transmitted to the user. The output device allows the user to view the program content and any additional information. Additional information may be any information inputted by a user, vendor, or service provider associated with the tag. The input device allows the user to request or send information to the base station for processing.

Tag marks may be displayed on the output devices for the user to activate in order to receive additional information. The output device may have a multi-view modality to allow the program and the additional information to be viewed concurrently.

### BRIEF DESCRIPTION OF THE DRAWINGS

FIG. 1 is a block diagram of an embodiment of the present invention;

FIG. 2 is a flow diagram of an embodiment of the present invention;

FIG. 3 is an embodiment of the output device displaying the various features of the present invention;

FIG. 4 is an embodiment of a webpage of the present invention;

FIG. 5 is a flow diagram for viewing marks and additional information according to the present invention;

FIG. 6 is a flow diagram for marking and characterizing an object;

FIG. 7 is a flow diagram for the voting process;

FIG. 8 is a flow diagram for receiving a vote; and

FIG. 9 is a flow diagram for bidding on an item.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

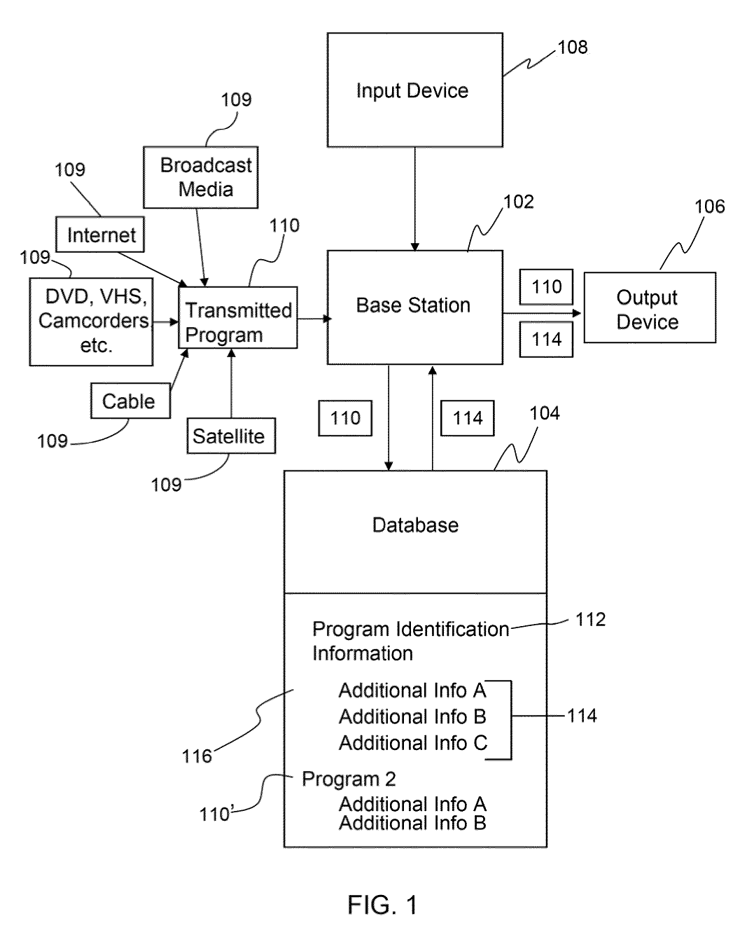

The program content tagging system 100 provides a method and device for facilitating the development of an interactive social network during the viewing of a program by making program viewing an interactive and comprehensive process where users can request, send, buy, sell, and inquire about merchandise, and view additional information 114 associated with the program that normally would not be provided with the program. As shown in FIG. 1, such a program content tagging system comprises a base station 102, a database 104, an output device 106, and an input device 108. The base station 102 serves as the conduit for bidirectional communication between the user and the output device 106. The database 104 comprises program information, such as a library of stored program content 110′ and/or other program identification information 112 to provide a means for identifying the transmitted program content 110 transmitted to the user. Transmitted program content 110 may be the actual program being viewed, whether it is informational, educational, entertainment, or the like. The output device 106 allows the user to view the transmitted program content 110 and any additional information 114. Additional information 114 may be any information inputted by a user, vendor, or service provider associated with an object 302 in the transmitted program content 110. The input device 108 allows the user to request or send information to the base station 102 for processing.

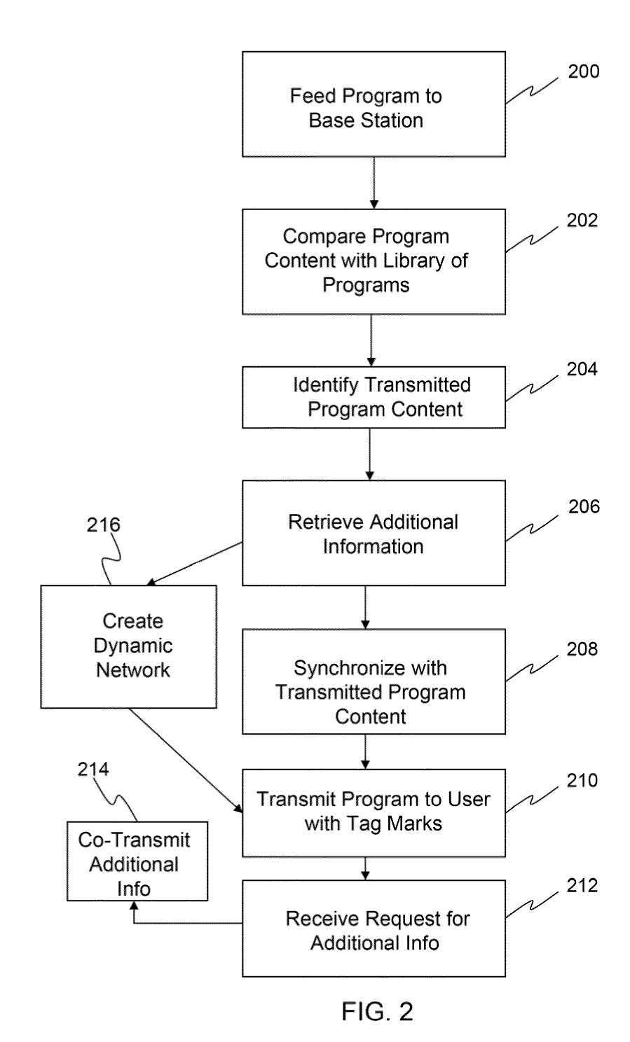

With references to FIG. 2, once the base station 102 receives 200 a feed of a transmitted program 110, the base station 102 compares 202 the program content 110 to the library of programs 116 in the database 104 to identify 204 the transmitted program content 110. In some embodiments, once the transmitted program content 110 is identified 204 any additional information 114 associated with the program content is retrieved 206. The retrieved additional information 114 is synchronized 208 with the program content 110 and ready for co-transmission. This eliminates the need for embedding data into a feed. In some embodiments, once the additional information is retrieved, a dynamic network may be created with others who watch or have watched the program content 110 to provide direct communication instantly or delayed in which additional information 114 may be shared.

In some embodiments, upon request of the user, the program content 110 is transmitted 210 to the user with tag marks 300. Tag marks 300 are indicators to identify an object that contains additional information. A request 212 for the additional information 114 is received by the base station 102 when the user activates the tag mark 300. When the tag mark 300 is activated, the additional information 114 is co-transmitted 214 to the output device 106 along with the program 110.

In addition, the user may tag objects 302 in the program 110 to provide his additional information 114 regarding the program 110 or the tagged object 302. Thus, users are able to interact with the program 110 by tagging the program content 110 with tag marks 300 and providing the additional information 114 associated with the object tagged, and viewing the additional information 114 provided by others.

A transmitted program content 110 may be any television show, movie, music, video, news, commercial, infomercial, documentary, and the like transmitted through wires or wirelessly from one source to the base station 102. The base station 102 may receive a transmitted program content 110 from a variety of sources 109. The transmitted program content 110 may be transmitted from broadcast media, internet media, DVD player, Apple TV, VHS, digital video recorder, cable, satellite transmission, gaming device, stereo system, iPods, or any other audio, video, or audiovisual sources.

The base station 102 may comprise a central processing unit that can perform a number of different functions. The base station 102 comprises at least one processor coupled directly or indirectly to memory elements through a system bus. The memory elements can include local memory employed during actual execution of a program code, bulk storage, and cache memories that provide temporary storage of at least some program code in order to reduce the number of times code is retrieved from bulk storage during execution.

The base station 102 may further comprise a computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

Network adapters may also be coupled to the base station 102 to enable the processing unit to become coupled to other data processing systems or remote printers or storage devices through intervening private or public networks. Modems, cable modem, and Ethernet cards are just a few of the currently available types of network adapters.

The base station 102 sends, receives, and processes requests and information. This can be accomplished through an internet connection, wirelessly or though hard connections, such as cable or phone lines. The base station 102 may also be connected to the peripheral devices, such as the input device 108 and output device 106 wirelessly or through hard connections. This technology can also work as a plug-in on web browsers or software on a computer, which allows the user to merge broadcast media with the synchronized program content. The base station 102 compares and identities transmitted program contents 110, then synchronizes the additional information 114 associated with the transmitted program content 110, and displays the unmodified transmitted program content 110 on an output display and simultaneously with the additional information.

In some embodiments, the base station 102 may have the program content 110 stored in the database 104 for later viewing similar to a digital video recording device. Frames or screen shots may be recorded and transmitted to other users for discussion and commentary.

The base station 102 may accommodate multiple users. Each user can have a unique identification. Each time a user views a program 110, the user can log in so that any additional information 114 requested or submitted may be associated with the current user as opposed to the specific base station 102.

The database 104 provides a means for identifying the received program content 110 and retrieving any additional information 114 associated with the program content 110. Identification of a program 110 can be conducted in a variety of ways. The base station 102 may compare at least a portion of the program content 110 and/or source information to a library of programs 116 in the database 104 to find a match.

The database 104 may be a central database maintained by a service provider, a network of databases, an ad hoc network or group, a local hard drive, and the like. Thus, the stored program content 110′ on a user's own computer may be accessed.

The database 104 may require a network connection for access, such as through the Internet. As is well known to those skilled in the art, the term “Internet” refers to the collection of networks and routers that use the Transmission Control Protocol/Internet Protocol (“TCP/IP”) to communicate with one another. The internet 20 can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize analog telephone lines, T-1 lines, T-3 lines, or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

The database 104 may contain a library of program identification information 116 such as entire stored program content 110′ or partial programs or broadcast media schedules, and other embedded data or source information, such as titles, authors, directors, producers, time and channel of the broadcast, and the like to help identify the transmitted program content 110. Thus, it is not necessary for program content authors or program content providers (such as television stations, cable television service providers, satellite television service providers, and the like) to make any modifications to the program content to facilitate identification of the transmitted program content 110. Existing programs 110 can be identified in their current forms.

To determine the proper identification of a transmitted program content 110, the program content 110 and the program identification information 112 or the stored program content 110′ in the library may be compared. Comparisons between transmitted program contents 110 and stored programs 110′ may take a variety of forms. For example, if the program is in digital form, the codes of various frames or sequence of frames may be compared. Thus, pixelation may be analyzed based on color and position within a screen using various statistical algorithms. If the program is in analog form, the frequency and amplitude may be compared using various statistical algorithms. These methods may be employed for both video and audio works. These comparisons may be made at randomly sampled segments. An algorithm may be implemented to eliminate false negatives and false positives. In one example, a transmitted program content 110 may be identified by comparing an identifier of the transmitted program content 110 with an identifier of the stored program content 110′. The identifier is established by quantization of each channel of an image using YCbCr, to determine the luma components and chroma components of the image. Utilizing the Bhattacharyya distance and the Bhattacharrya coefficient, the similarity of the transmitted program content 110 and the stored program content 110′ can be determined. All stored program contents 110′ having a similarity above a predetermined threshold is indicated. Then the process can be repeated again on random frames of the above-threshold programs to confirm a single match.

In some embodiments, only segments of an entire program content 110 may be stored in the database 104. Through a process referred to as video indexing, the amount of information stored in the database 104 may be reduced compared to storing entire program contents in the database 104. Video indexing using motion estimation helps to automate the visual differences between shots in a given film. Video indexing facilitates efficient content-based retrieval and browsing of visual information stored in large multimedia databases. To create an efficient index, a set of representative key frames are selected which capture and encapsulate the entire video content. These representative frames may be selected using a specific algorithm or random frames for spot checking. This is achieved first, by segmenting the video into its constituent shots and, second, selecting an optimal number of frames between the identified shot boundaries. The segmentation algorithm is designed to detect both abrupt shot transitions or cuts, and gradual transitions, such as dissolves and fades. This is achieved by means of a two-component frame differencing metric taking both image structure and color distribution into account. The application of hierarchical block-based normalized correlation and local color histogram differences leads to a method which is both accurate and robust.

Once the program content 110 has been identified, the associated additional information 114 may be retrieved, and synchronized to the program content 110 so that the viewing experience is ready to become interactive. The additional information 114 may be embedded with a synchronization mechanism, such as a time stamp, and a tag mark. The synchronization mechanism keeps track of the running program 110 and displays the tag mark 300 at the appropriate time and location on the output device 106 during the transmission of the program content 110. If the user is interested in the tagged object, the user can activate the tag mark 300 using the input device 108 and request the additional information 114 associated with the tag mark 300. The additional information 114 may then be retrieved from the database 104 and displayed on the output device 106. In addition, the user has the opportunity to create his own tag marks 300 on an object 302 in the program 110 and input his own additional information 114 on the program 110 being viewed.

During the identification step, the program may or may not be identified depending on the comprehensiveness of the library. If the program is not identified, the user can add additional information 114 to the program 110. For example, the user may be given the option of adding additional information 114 or simply viewing the program. If the user chooses to add additional information 114, the user may be prompted to enter a variety of information about the program 110 or objects in the program 110. The base station 102 may have predetermined questions to query the user regarding the program content 110 that will allow the program content 110 to be identifiable by subsequent users. In addition, the media provider may also be queried to retrieve identifying information. After these preliminary steps have been taken, the program 110 is sent to the output device 106 for viewing by the user and the viewer may add tag marks 300 if he desires.

Once all the additional information 114 is integrated it has to reach the appropriate viewer at the appropriate time. The robust computing power of the base station 102 at this point quickly communicates to the database 102 what the viewer is doing. From this simple information the base station 102 knows what data to send back to the output device 106. The base station 102 can tell when the feed is paused, when the channel is changed, and when a new input is selected. Whether the user is chatting with a friend, tagging content for the public to view, or clicking on a tag mark 300 to purchase an item, the base station 102 is on top of the steps to take that interaction to the next step. The base station 102 may sample the program 110 every second or some other predetermined time frame to determine whether the program 110 has changed.

This system also allows the base station 102 to detect a commercial break. The base station 102 can then search through the database 104 to determine whether the commercial being played has any additional information 114 associated with it. Any additional information 114 and/or tag marks 300 can then be displayed with the commercial so that the user can make purchases or request additional information 114.

The tagging process can be achieved in a variety of ways. In some embodiments, the base station 102 collects data regarding objects 302 in the program 110 so that the object 302 can be identified and tracked. An object 302 may be any person, place, or thing displayed on the output device 106. Object tracking and recognition has been documented to succeed in recognizing objects 302 including faces. This technology is already used in software like Adobe® Photoshop® for image modification and only requires the additional development of dynamic tracking software to allow the software to understand that an object might move or change shape but remains the same object. This study shows how the human is able to recognize angles of objects that have never been viewed before through complex object recognition. The entertainment content tagging system utilizes this unique logic and applies it toward objects 302 shown on the screen. For example, with this logic, if the understanding of a certain cell phone is logged in the database, a data feed with only a part of that phone is required to acknowledge an object match. This object recognition process may be enhanced by allowing users to provide their input on what an object is. This allows the social network to help a computer learn.

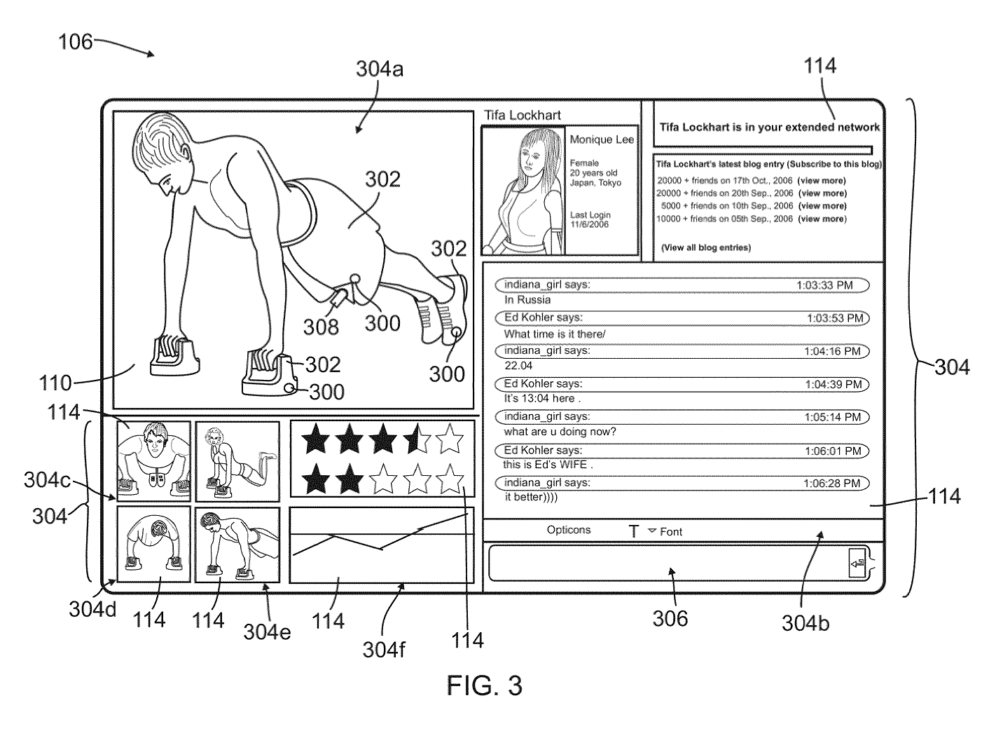

The extent of interaction a user can experience is dependent on users' inputs. Adding tag marks 300 may take place concurrently with viewing of the program 110. While viewing the program content 110 the user can use any type of input device 108 operatively connected to the base station 102 to send a command such as adding a tag mark 300. The input device 108 may be a remote control, a keyboard, a keypad, a mouse or mouse-type device, a joystick, a gaming device, and the like. When the user sees an object 302 of interest, the user can press a button on the input device 108 to tag the object 302 or the current screen frame. An option may be provided where the user can input the additional information 114 for that object 302 or frame at that time or at a later time. For example, as shown in FIG. 3, the output device 106 can display the program content 110 and an auxiliary display 304, such as a split screen, a second window, a toolbar, a task pane, and the like, so as not to obstruct the viewing of the original program content 110, where the user can view and input additional information 114.

In some embodiments, the user can tag the object 302 or screen shot and input the additional information 114 at a later time, for example, on his computer, and transmit the additional information 114 to the database 104, for example, via e-mail or the Internet. Each base station 102 may have a unique identification so that the database 104 can keep track of which base station 102 has sent the additional information 114 and for which program 110. In some embodiments, the individual user may be kept track of, for example, when there are multiple users for a single base station 102. If the user utilizes a computer to transmit the additional information 114 the computer can send the additional information 114 to the database 104 through the base station 102 so that the database 104 knows which tag to associate with the additional information 114. In some embodiments the user can simply identify the base station 102 from which the tag was sent as he saves the additional information 114 directly to the database 104. Any other electronic communication device connectable to the internet may be used to add the additional information 114 to the database 104. Once the additional information 114 is sent, the tag mark 300 can be linked to the additional information 114.

To tag screen shots or objects, the user uses his input device 108. In some embodiments, the input device 108 may feature a cursor 308 such that pointing the input device 108 at the screen displays the cursor 308. The user can then place the cursor 308 over the object 302 he wants to tag and press a button. In some embodiments, a highlighting tool may be used to allow the user to draw a box, a circle, an oval, or various other shapes to encapsulate a substantial portion of the object. In some embodiments, the highlighting tool may allow the affiliate to outline a substantial portion of the item by freehand. Once the object 302 has been tagged, the object recognition process may be applied so that the object 302 can be identified in previous or future frames or screen shots. User inputs can also be accessed to identify the object if the frame and object location has been identified.

In some embodiments, the object recognition process may be achieved using mathematical morphology techniques to detect edges and identify the object in an image. Once an object is highlighted the quantization and extraction of the color of the background pixels surrounding the object can be performed. Quantization reduces the number of colors in the selected region of interest. A search through the image is computed to mark the pixel as a black pixel if found to be a background color. Once the background is extracted, the image of the object can be converted from an RGB image to grayscale image, for example, using the formula Y=(0.3*red)+(0.59*green)+(0.11*blue), where Y is the grayscale image of the object. The grayscale image can then be converted to a binary image. Connected component analysis or connected component labeling may be used to detect unconnected regions to further distinguish background from the image or from one image from another image. Dilation and erosion techniques are also used to distinguish the object image from the background or another image. Adaptive thresholding may be used to calculate the adaptive threshold for every input image pixel and segments image. The algorithm is as follows: Let f(i,j} be the input image. For every pixel i,j the mean m(i,j) and variance v(i,j) are calculated in a fixed neighborhood. Local threshold for the pixel is calculated based on the mean and variance as t(i,j)=m(i,j)+v(i,j) for v(i,j)>v(min) and t(i,j)=t(i,j)−1 for v(i,j)<=v(min) where v(min) is the minimum variance value. Extraction of the largest connected component (edge) may be performed by performing a connected component analysis on the image and labels different regions, then extracting the largest connected component which represents the outermost contour surrounding the object. Once the object image is isolated and distinguishable from the background and other objects, the user may select the object image again to confirm that the object selected is indeed the object the user intended to select.

Once the selection of the object image has been confirmed, a mask is created of the object image using a flood fill algorithm. The object image can then be tracked through the program content. A manual override is provided for the user to make corrections if necessary. A tag mark 300 is then placed on the object image and tracks the object image throughout the program.

To track the image, the frame rate of the transmitted program content 110 is determined. The object is then located in each frame. The tag mark 300 is incorporated into an overlay at the same frame location and at the same general location of the object in the program and played simultaneously to track the object image.

To track the object image, a histogram in hsv (hue, saturation, value) space of the object is calculated. The backprojection image is then calculated. For each tuple of pixels at the same position of all input single-channel images the function puts the value of the histogram bin, corresponding to the tuple, to the destination image. In terms of statistics, the value of each output image pixel is the probability of the observed tuple given the distribution (histogram). Iterations of a continuously adaptive mean shift algorithm is performed to find the object center given its 2-dimension color probability distribution image. The iterations are made until the search window center moves by less than the given value and/or until the function has done the maximum number of iterations. Computation of the similarity measure is then performed to compute the Bhattacharyya coefficient between the reference template and the searched template in the hsl (hue, saturation and lightness). If the measure is less then the threshold, the object is visible and if not it computes a global search in the frame. If the object is not detected then it is marked as not present in the current frame.

Once a tag mark 300 and its affiliated additional information 114, collectively referred to as an object mark, have been submitted to the database 104, a user can see the tag mark 300 while viewing the transmitted program content 110. To avoid having to modify the transmitted program content, the tag mark 300 may be transmitted as an overlay synchronously and simultaneously with the transmitted program content 110. Thus, the tag mark 300 can be displayed or removed during the viewing of the transmitted program content 110 at the discretion of the viewer.

The tag mark 300 can be in many different forms to let the user know that a particular scene, person, place, or thing being viewed has been tagged. The simplest example is to place a visible dot on the tagged object that follows the tagged object as it moves from frame to frame. If the user is interested in the object, the user can use the input device 108 to activate the tag. In some embodiments, the program content 110 can be placed on pause while the additional information 114 is displayed on the output device 106. In some embodiments, the split-screen or multiple window function may be used to view the additional information 114.

For screen shots containing a plurality of tag marks 300, the user can use the input device 108 to toggle from tagged object 302 to tagged object 302 until the desired tagged object 302 is highlighted. The user can then select the desired tag mark 300. In some embodiments, the input device 108 can control a cursor 308 and the user can position the cursor 308 on the desired tag mark 300 and select the tag mark 300. On some occasions, a particular object 302 may have been tagged by numerous users. In such instances, selecting a tag mark 300 would display a list of the additional information 114, and optionally some form of identifying information of the person who had submitted the additional information 114, so that the user can select the desired additional information 114 to view.

To reduce the interruption of viewing the program content 110, in some embodiment, selecting a tag mark 300 may send an email to the user and/or populate an online profile with the additional information 114. When the user has completed viewing the program 110, he can check his email and/or profile to see all the additional information 114 associated with the respective tag marks 300 that he had selected while viewing the program 110. This can be an option provided to the user at the time he selects a tag mark 300 or at some other time. For example, the user could set his base station 102 to email all additional information 114, present the additional information 114 at the end of the program 110, present the additional information 114 during commercials, present the additional information 114 in a second window, or at any other time.

The output device 106 can be any type of television, high-definition television (HDTV), monitor, computer monitor, projection screen, LCD display, speakers, mobile phone, iPod, and any other peripheral device capable of reproducing audio and/or video information. In some embodiments, as shown in FIG. 3, the output device 106 has a multi-view modality 304, such as a split-screen function, a picture-in-picture function, a plurality of windows, or any other means for displaying information from multiple feeds on a single output device. This would allow the program content 110 to play continuously while the additional information 114 is displayed to enhance the social networking experience. Alternatively, multiple different programs may be viewed simultaneously utilizing the split-screen function.

The additional information 114 can be any type of information or communication submitted by a user, a vendor, the service provider, or any other party having access to the system to establish a social network. Additional information 114 includes such information as descriptions of objects, background or historical information, news, current invents, comments, commentaries, chats, recommendations, reviews, ratings, commercials, advertisements, statistics, user profiles, and any other communications with one or more parties regarding program content to make viewing the program content a more comprehensive and robust experience. In utilizing the chat function, an entire network can be viewing the same program and interacting with each other in real time.

In the split-screen embodiment, the screen may be split into as many screens necessary to view all information. Each screen may be fed different information in parallel. As an example, the user may be viewing a program content 110 on a first screen 304a. On a second screen 304b he may be engaged in a chat room related to the program 110. A third 304c, fourth 304d, and fifth screen 304e may display different advertisements related to a selected tag mark 300. A sixth screen 304f may display other types of information related to the program, such as viewer ratings of the program, number of viewers watching the program, user profiles, and the like. In some embodiments, the user may be able to zoom in on certain portions of the screen to get a better look at a particular image.

The input device 106 may be any type of remote control, keyboard, keypad, mouse or mouse-type device, joystick, gaming device, and the like, communicably linked to the base station 102 and the output device 106. The input device 108 may be modified with the proper keys to perform the necessary functions. With the input device 108 the user can interact with the program content 110. For example, the user can tag the program content 110. The user can also designate whether the tagged information will be open to the public or designated as private. Tags designated as private may require passwords to access or be presented only to predetermined users.

The user can also use the input device 108 to rate the program content 110 or the additional information 114 being presented on the output device 106. For example, if advertisements are concurrently being displayed as additional information 114 the user could rate the advertisement, the vendor associated with the advertisement, and/or the product, or any other information associated with the additional information 114.

Each of the additional information 114 submitted by the user may be screened by the service provider to promote decency and fair play.

To improve the efficiency of program and data transmission, users may be required to register for the service. Registration involves the submission of the standard information for identification, access, and payment, such as identification information, user profile, user name, password, and the like. This allows the service provider a means to identify and contact users. It also allows the service provider to associate the tag marks 300 with the user submitting those tag marks 300. In addition, each base station 102 may have a unique identifier so that the service provider can identify the base station 102 making requests for additional information 114 or submitting tag marks 300 and additional information 114.

In addition, all user activity may be logged by the base station 102 to enhance the user's experience. The base station 102 may recommend particular programs or network of users with similar interests based on the user's viewing and tagging habits.

The tagging system not only enhances social networking, but it will improve internet-type commerce not only for vendors but also for individual users. Using tag marks 300 to tag objects 302 for purchase, whether in a commercial, infomercial, or regular programming allows instant purchase without leaving the television or accessing a separate computer or telephone.

Users can also tag objects to indicate that they have the product or a similar product for sale. Clicking on the tag marks 300 associated with items for sale can display additional information 114 regarding the product the vendor or the user has to sell. User's can then rate the sellers, whether vendors or individual users, which can also be displayed as additional information 114. This can form a type of public auction on the television.

In some embodiments, the present invention allows users to derive income through tagging of objects 302 and facilitates advertising by allowing sellers to place bids on the tag marks 300. For the ease of discussion, a viewer refers to a user who views the program content 110 to gather information; an affiliate is a user who qualities to mark program contents for revenue; and a seller is a user who utilizes the services of the website to sell merchandise or services.

Once the program is installed on a computing device, thereby converting the computing device into the base station 102, the application can be used in conjunction with any program content 110 being viewed 500. The computing device can be any electronic device with a processor, sufficient memory to execute the application, an input device and an output device. For example, the computing device may be a computer, cell phone, smart phone, iPod, personal digital assistant, television, and the like.

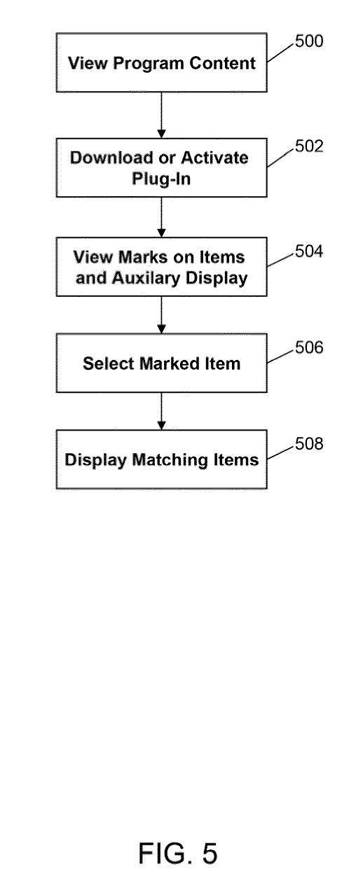

With reference to FIG. 5, the user can visit any website, such as youtube.com, in which a video can be played. If the user activates 502 the plug-in application, tag marks 300 and an auxiliary display 304 are shown 504 concurrently with the original program content 110. The auxiliary display 304 comprises functional buttons 400 that allow the user to perform a variety of functions, such as viewing marked items; selecting 606 marked items to purchase, gather additional information, or provide additional information; marking items; or bidding on items.

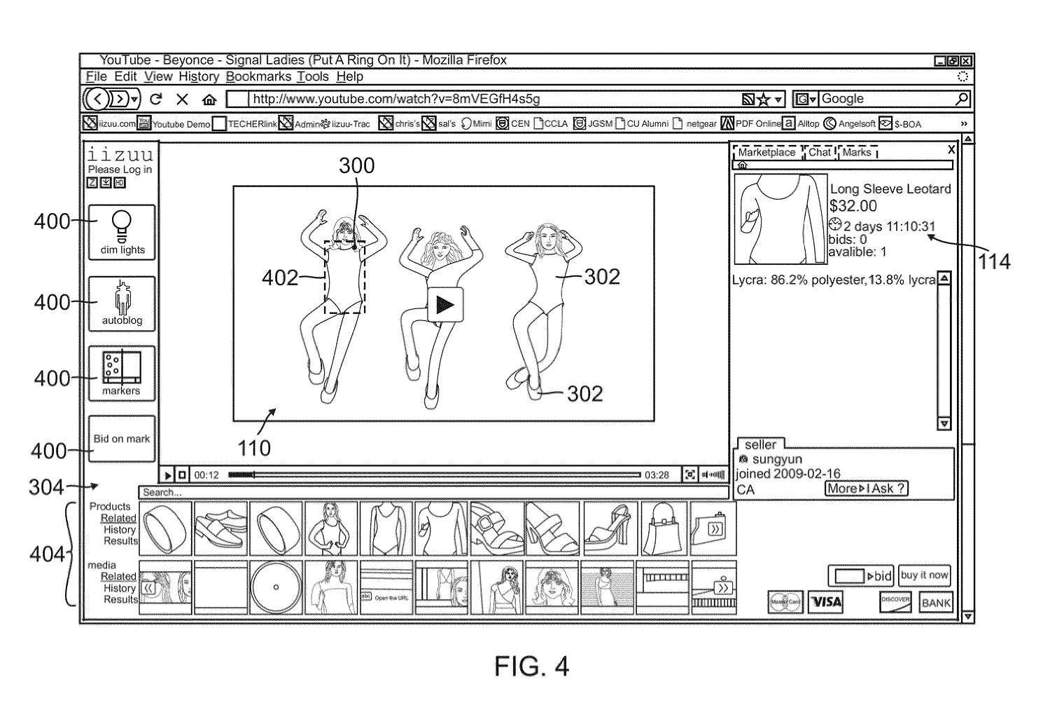

As shown in FIG. 4, the auxiliary display 304 may be displayed as a new window, a split window, a toolbar, a task pane, and the like, so as not to obstruct the original program content 110. If the user qualities as an affiliate, the user can mark objects 302 in the program content 110 with a tag mark 300. If the program content 110 is marked by an affiliate, the identification of the program content 110 is stored in the database 104. Each time a user activates the plug-in application, the identification of the program content 110 is compared with program contents in the database 104 to determine whether the program content 110 has been previously marked by any affiliate. The user can then actuate a functional button 400 to display the tag marks 300 on the objects.

The tag mark 300 essentially stakes claim in virtual ownership of an object 302 in a program content 110. To be clear, the tag mark 300 does not confer any ownership of the actual good represented by the object 302, nor does the tag mark 300 confer any actual ownership to any portion of the program content 110. Rather, the tag mark 300 precludes others from marking the object 302 and a specific program content 110 and having that marked object 302 characterized in association with the tag mark 300. Thus, the ownership is in the right to mark an object 302.

Tag marks 300 can be dots, outlines, shadows, highlighting, or any other type of discreet marking so as to avoid any significant alteration or obstruction of the program content 110. In some embodiments, no actual visible mark may be shown on the program content. Rather, moving the cursor 308 over a particular object 302 indicates in the auxiliary display 304 whether the object 302 has been marked, and if so, displays any additional information 114 associated with the marking.

Actuating a tag mark 300 may display additional information 114 in the auxiliary display 304 regarding the object 302 marked. Additional information 114 includes any comments provided by an affiliate, such as the identification, description, and characterization of the item, identification of the seller, reviews regarding the item or the seller, links to the seller's website, information regarding related or competitive items, links to competitors, options for purchasing the item, and the like. The viewer can then select various items to view additional information 114 or purchase the item represented by the object 302 or a similar item.

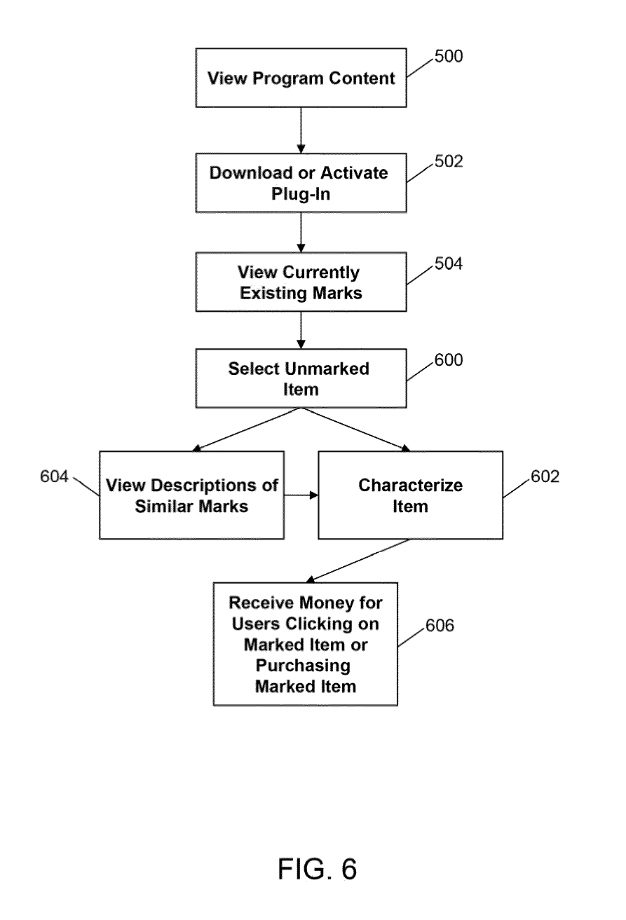

FIG. 6 shows a flow diagram of the marking process. If an object 302 has not been marked by a previous affiliate, the user, if he qualifies as an affiliate, can mark the object 302 and provide the additional information 114. To mark an object 302, an affiliate must view 500 a program content 110 and activate 502 the plug-in application. Once the plug-in application has been activated 502, functional buttons 400 on the auxiliary window are displayed. One of the functional buttons 400 may be a marker button to display currently marked objects 302 and allow the user to select an unmarked object 302. In some embodiments, activation of the marker button pauses a video to allow the affiliate to select a particular item using a highlighting tool.

The highlighting tool may allow the user to select an object 302 by drawing an outline 402 around the object 302, such as a box, a circle, an oval, or various other shapes to encapsulate a substantial portion of the object 302. In some embodiments, the highlighting tool may allow the affiliate to outline a substantial portion of the object 302 by freehand. Using a unique object recognition software, the entire object 302 can be automatically detected. The object recognition software can utilize edge detection, segmentation, motion tracking, affiliate input, and other methods to detect what the object is and where the object moves to throughout the video.

Once the object 302 has been selected 600, a tag mark 300 may be displayed on the object 302. The tag mark 300 may be discreet so as not to substantially alter the appearance of the object 302. In some embodiments, the tag mark 300 may not be displayed on the screen or monitor. Rather, the base station can keep track of the movement of the marked object 302 on the screen and when the cursor is placed over the object 302, the appropriate additional information 114 may be displayed in the auxiliary display 304. In essence, the object 302 itself becomes the tag mark 300.

After the object 302 is marked, the affiliate may characterize 602 the object 302. In addition, once the object 302 is marked, additional information 114 for related objects 404 that have been marked may be provided 604 to the affiliate to provide an idea of what others are writing about similar objects.

The additional information 114 is stored in a database and associated with the program content 110 and the affiliate providing the additional information 114. When other users view the same program content 110, the additional information 114 will be ready for display. If a viewer selects a mark 300 that leads to the purchase of a good or service associated with the mark 300, then the affiliate providing the mark 300 and additional information 114 receives 606 a percentage of the proceeds from the sale. Thus, it is important for affiliates to provide useful additional information 114 that encourages viewers to make purchases based on the additional information 114.

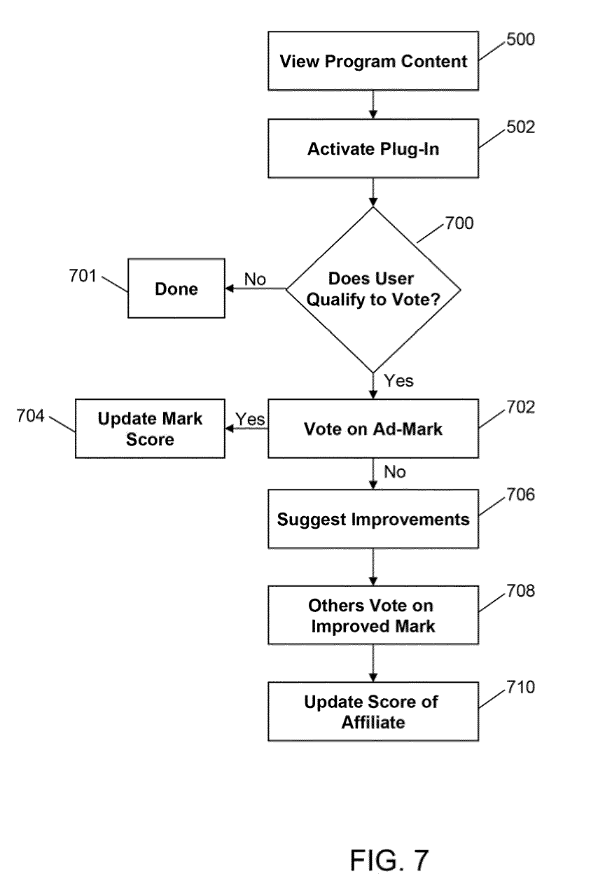

To that effect, with reference to FIG. 7, a voting system has been established to assure that additional information 114 is informative and useful to the viewers. In some embodiments, in order to participate in the voting system an affiliate must qualify 700 to be a voter based on predetermined criteria. If the affiliate does not qualify 701, then he cannot vote. For example, the criteria may be based on the affiliate's character, activity level, length of time the affiliate has maintained his affiliate status, and the like, or any combination thereof.

In the preferred embodiment, each affiliate may begin with an affiliate score. The affiliate score reflects the character of the affiliate. The affiliate score must be above a qualifying threshold in order for the affiliate to qualify as a voter. If the affiliate score drops below a disqualifying threshold, the affiliate may be disqualified from being an affiliate, permanently or for a predetermined period of time. A warning is sent to each affiliate as their internal mark score is updated.

An affiliate score can be affected by various activities by the affiliate, such as constructive comments to help improve others' marks, useless or tasteless criticism of others' marks, positive activity on the website, recruitment of others to the website, successful sales through the affiliate's mark, number of marks owned by affiliate, and other such activities that promotes traffic to the website and promotes use of the plug-in application and the website.

Each tag mark 300 also has a mark score. The mark score reflects the quality of the tag mark 300 and the additional information 114 as determined by votes from other affiliates. When a qualifying affiliate views the additional information 114 of a tag mark 300, the affiliate has an opportunity to either vote 702 on the mark 300 and the associated additional information 114, with the option of providing a brief comment, or submit an improvement 706 to the mark 300.

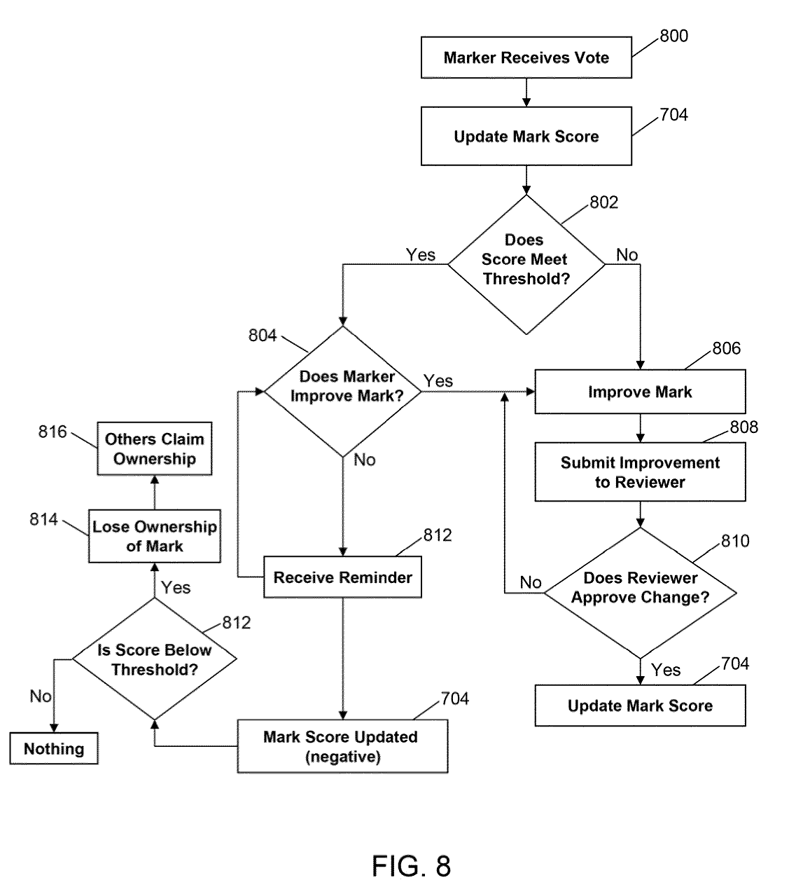

If the affiliate votes 702 (referred to as the voting affiliate) on the mark 300 and additional information 114 of an object 302 the mark score of that mark 300 is updated 704 or recalculated based on a unique algorithm. With reference to FIG. 8, once the owner receives a vote 800, the owner of the mark 300 has the opportunity to respond 804 or amend the mark 300. A predetermined threshold may be established 802 such that mark scores below the threshold require amending; otherwise, the owner may lose his rights in marking that object 302.

If the owner amends 806 the mark 300, the amended mark 300 is sent 808 to the voting affiliate. If the voting affiliate approves 810 the amendment, the mark score is recalculated 704 and is improved. In addition, the affiliate score of the voting affiliate may also be improved 710.

If the owner chooses not to amend the mark, the owner may receive 812 a reminder. If after a predetermined time or a predetermined number of warnings, the owner still does not improve his mark, then the mark score is recalculated 704 and decreases. If a predetermined score 812 is reached, the owner's right to mark that object is forfeited 814 and another affiliate may have the opportunity to take over 816 that right. By voting on a mark, however, an affiliate may lose his opportunity to own the right to mark that object. This may reduce a voting affiliate's collusive voting behavior, such as reducing an owner's mark in bad-faith in attempts to gain the rights to mark that object.

Referring to FIG. 7, rather than voting on a mark, an affiliate may submit 706 his own improvement of the mark and additional information pertaining to the mark. If an affiliate submits 706 his improved rendition of the mark, then this improvement becomes available for other affiliates to vote on 708 and the affiliate submitting the improvement becomes eligible for taking over the right to mark the object. Other affiliates may also submit their improvements to the additional information, which also becomes available for receiving votes.

If a predetermined criterion is met by the improved mark, the affiliate submitting the improvement may take over the right to mark that object and his affiliate score may be updated 710. For example, if the mark score of an affiliate's improved mark reaches a predetermined threshold, that affiliate may become the new owner of the right to mark that object and receive the proceeds associated with purchases made through that improved mark. In another example, a time period may be established and the affiliate receiving the highest mark score for their improved mark at the end of the time period may become the owner of the right to mark that object. Various other criteria for taking over the right to mark an object have been contemplated.

It is recognized that voting and rankings are subject to collusion, referred to as collusive voting. For example, friends can artificially inflate one's ranking and competitors can artificially lower another's rankings regardless of the quality of a mark. Those who have had negative experiences with each other may tend to lower each others scores out of retribution or retaliation. Those who have nothing to gain or lose may vote irresponsibly out of sheer boredom or heartlessness. None of these activities are productive to the consumer.

To minimize the effect of collusive voting, an anti-collusion algorithm may be applied to the votes that are received. The anti-collusion algorithm takes into consideration such factors relationships among voters and owners of marks being voted on, past voting behavior, affiliate status, and the like. By providing a means for reducing collusive voting, a ranking system is established that is more useful to the consumers. Thus, consumers are more likely to receive the product they want, and sellers continue make sales of quality products.

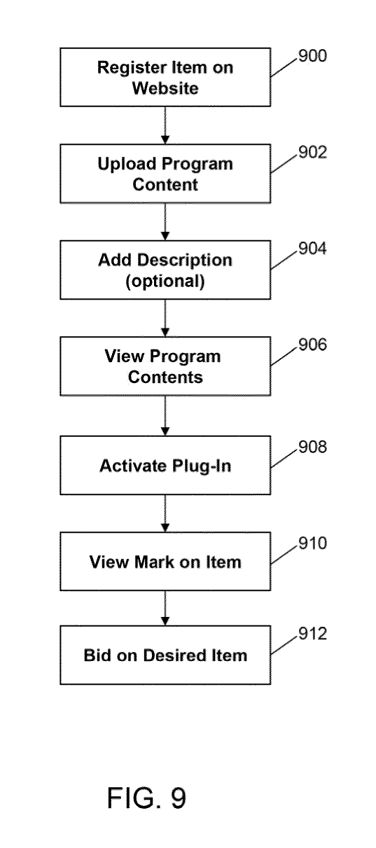

With reference to FIG. 9, in some embodiments, to make a product available for sale through the website, the seller must register 900 with the website. The seller then uploads images 902 and descriptions 904 of the items he wants to sell, which is stored in the database. When a viewer selects a mark 300 on an object 302 to view the additional information 114, a matching algorithm is executed and the database is searched to find the items having images and descriptions matching the object 302 selected by the viewer. Matches are then displayed 508 in the auxiliary display 304 as additional information 114 according to rank order based on a match score. These matches can include links to the seller's website or the ability to purchase the item directly through the website of the present invention. The affiliate who marked and characterized the object then receives a fee if his mark was actuated for the sale of the item. The fee may be a percentage of the sale, a flat fee, or some other amount pre-arranged by the affiliate and the seller.

A set of rules may be established to determine whether the affiliate receives his fees for the purchase of an item through the actuation of his mark. For example, the item purchased may have to be the item having the highest match score or the item may have to be the exact item as the object as opposed to a related item. Thus, in some embodiments, the affiliate may not get a fee if an item different from the marked object is purchased. Many other criteria may be established to determine whether the affiliate gets a fee for his mark.

The match score is calculated by the matching algorithm. The matching algorithm is based on the similarity of the object selected by the viewer and the image and description uploaded by the seller. The matching algorithm takes into consideration such factors as color, brightness, shape, movement, relationship and proximity to other objects, and the like to help identify the object. The matching algorithm also takes into consideration the description provided by the owner of the mark and the description provided by the seller. The more matching elements that are found between marked objects and sellers items, the higher the match score.

A seller may improve his match score by bidding on a mark. For example, if a seller views 906 a program content that he finds particularly appealing, he can activate 908 the plug-in, view the marked items 910, and bid 912 on that mark for that program content 110. The matching algorithm factors the bid into the calculation of the match score. Depending on the amount of the bid, the bid can be heavily weighted in calculating the match score. Therefore, a seller can bring its products to the top of a list of items for purchase associated with the marked object 302.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A method of providing an interactive program content, comprising:
a. receiving a transmitted program content at a base station,
b. comparing the transmitted program content to a library of program information in a database to identify the transmitted program content, the library of program information selected from the group consisting of an entire program, a partial program, and a program identification information,
c. retrieving additional information associated with the transmitted program content once the transmitted program content is identified;
d. synchronizing the retrieved additional information with the transmitted program content;
e. displaying the transmitted program content synchronously with an overlay on an output display, wherein the transmitted program content is unmodified, wherein the overlay comprises a tag mark associated with an object in the transmitted program content, wherein the tag mark tracks the object during the display of the transmitted program content, and wherein the tag mark can be actuated;
f. receiving a request for the additional information of the object through the actuation of the tag mark associated with the object via an input device; and
g. displaying the additional information on the output display without encumbering the transmitted program content.

2. A method of providing an interactive program content, comprising:
a. receiving a transmitted program content at a base station,
b. comparing the transmitted program content to a library of program information in a database to identify the transmitted program content,
c. once the transmitted program content is identified, retrieving additional information associated with the transmitted program content;
d. synchronizing the retrieved additional information with the transmitted program content;
e. displaying the transmitted program content synchronously with an overlay, wherein the transmitted program content is unmodified, wherein the overlay comprises a tag mark associated with an object in the transmitted program content, wherein the tag mark tracks the object during the display of the transmitted program content, and wherein the tag mark can be actuated.

3. The method of claim 2, further comprising:
a. receiving a request for additional information of the object by actuating the tag mark associated with the object; and
b. displaying the additional information on the output display.

4. The method of claim 2, further comprising:
a. receiving a request for additional information regarding the object by actuating the tag mark associated with the object; and
b. sending the additional information to a user.

5. The method of claim 2, further comprising:
a. receiving a tagging request for the object; and
b. receiving the additional information regarding the object.

6. The method of claim 5, further comprising providing an auxiliary display to view the additional information being submitted.

7. The method of claim 2, further comprising:
a. receiving a tagging request for a different object; and
b. receiving a new additional information regarding the different object.

8. The method of claim 2, wherein identification of the program transmission comprises comparing at least a portion of the program transmission to a library of program information in the database to find a match.

9. The method of claim 8, further comprising selecting a key set of representative frames unique to the transmitted program content to compare in the library of program information in the database.

10. The method of claim 2, wherein identification of the program transmission comprises comparing a source information of the program transmission to a library of program information in the database to find a match.

11. The method of claim 2, further comprising:
a. detecting an interruption in the transmitted program content by a second transmitted program content;
b. comparing the second transmitted program content to the library of program information in the database to identify the second transmitted program content,
c. once the second transmitted program content is identified, retrieving additional information associated with the second transmitted program content;
d. synchronizing the retrieved additional information of the second transmitted program content with the second transmitted program content;
e. displaying the second transmitted program content synchronously with a second overlay, wherein the second overly comprises a second tag mark associated with a second object in the second transmitted program content, wherein the second tag mark tracks the second object in the second transmitted program, and wherein the second tag mark associated with the second object can be actuated.

12. A program content tagging system, comprising:
a. a base station to receive a transmitted program content;
b. a database in operative communication with the base station to store a program information;
c. an output device in operative communication with the base station to display the transmitted program content in an unmodified form and to display an overlay, the overlay comprising a tag mark tracking an object in the transmitted program content; and
d. an input device in operative communication with the base station to submit a request to the base station from a user, wherein the base station serves as a conduit for bidirectional communication between the user and the output device, wherein the database stores a library of program information to identify the transmitted program content received at the base station.

13. The system of claim 12, wherein the output device displays the transmitted program content and an additional information, wherein the additional information may be information inputted by a party selected from the group consisting of a user, a vendor, and a service provider.

14. The system of claim 13, wherein the output device comprises a multi-view modality to display the additional information without encumbering the transmitted program content.

15. The system of claim 12, wherein the database is selected from the group consisting of a central database maintained by a service provider, a network of databases, and an ad hoc network.

16. The system of claim 12, wherein the library of program information is selected from the group consisting of an entire program, a partial program, and a program identification information.

17. The system of claim 16, wherein the program identification information is selected from the group consisting of a broadcast media schedule and a source information.
